(19) United States
(12) Patent Application Publication
(10) Pub. No.: US 2022/0037971 A1
(43) Pub. Date: Feb. 3, 2022

(54) Magnetodynamic propulsion system and method

(71) Applicant: Harold A. Tavarez, Compton, CA (US)

(72) Inventor: Harold A. Tavarez, Compton, CA (US)

(21) Appl. No.: 16/873,854

(22) Filed: Jul. 28, 2020

(51) Int. Cl. H02K 16/02; H02K 1/17; H02K 1/27; B64G 1/40

(52) U.S. Cl. CPC H02K 16/02; H02K 1/17; B64D 33/00; B64G 1/409; H02K 1/27

(57) ABSTRACT

The present application discloses a propulsion system and method of propulsion which provides thrust without the ejection of propellant, without reaction, and without an external mass to react against. The basic propulsion system comprises; a means for motion, an electric motor, that convey rotary motion to a source of magnetic field, a rotor generating a magnetic field that interact magnetically with a stationary source of magnetic field, a stator, generating a stationary magnetic field. Magnetic interactions between the spinning magnetic field interacting magnetically while moving through the magnetic field space of the stationary magnetic field; generates a gyroscopic force and a Lorentz force without the ejection of propellant; without reliance on an external mass to react against, and without reaction as recognized in the Newton's Third Law Exception in accordance with the established principles of electrodynamics and modern physics.

### CROSS-REFERENCE TO RELATED APPLICATIONS

[symbol]

### FEDERALY SPONSORED RESEARCH

Not Applicable

### SEQUENCE LISTING OR PROGRAM

Not applicable

### BACKGROUND

### Field

The present application relates to the interactions between magnetic fields that generate propulsion with the gyroscopic force and the Lorentz force without the expulsion of propellant.

### Prior Art

Propulsion without propellant is useful for space travel and for means of transportation that travel on land, air, and water. Each of these modes of travel requires a dedicated and specific type of propulsion system. In this regard, replacing the assortment of propulsion systems in present use with propellantless propulsion; is a more advantageous and energy efficient prime mover that will benefit all modes of transportation.

For propulsion, an internal combustion engine with a drive train delivers the power to drive the wheels of a land driven motor vehicle. The ground in contact with the wheels serves as propellant. In aerospace, gas turbine engines depend on air and fuel for propellant. Propellers employ the air and water as propellant. While useful for air and space travel; rocket engines are limited by the propellant stored in the rocket fuselage to deliver propulsion in the atmosphere and in the vacuum of space.

Practical space drives that generates thrust without propellant for space travel and for the propulsion of satellites in orbit; are still a dream not yet fully achieved, but not for the lack of efforts by the workers in the field. All the current modes of propulsion have limited propulsion capabilities due to the limitations imposed by the need for propellant.

Examples of propellantless propulsion in the prior art shows;

Purvis U.S. Pat. No. 10,006,446 B2 utilizes multi-element capacitor with segmented rotating cathodes interacting with electromagnetic coils generating magnetic fields.

Purvis U.S. Pat. No. 10,135,323 B2 discloses and apparatus and method for propulsion utilizing capacitor assemblies and electromagnetic Helmholtz coils to generate propellantless thrust.

Delroy U.S. Pat. No. 5,090,260 discloses a gyroscopic propulsion system for producing a controlled unidirectional movement in a predetermined direction based on gyrostatic precession.

Rodgers U.S. Pat. No. 5,054,331 is a controllable gyroscopic propulsion apparatus that develop a controllable propulsion force in a desired direction.

Kethley U.S. Pat. No. 4,784,006 discloses a gyroscopic propulsion device that generates a propulsion force with an annular body rotating about the eccentric second axis of the body.

### SUMMARY OF THE INVENTION

The present embodiment employs a novel propulsion method that generates thrust with the magnetic interactions between magnetic fields to generate with magnetic field action at a distance; gyroscopic forces and Lorentz forces without the ejection of propellant. The basic elements are a magnetic field generating rotor and a magnetic field generating stator. The embodiment of the method in a propulsion system comprises a rotor as a source of magnetic field; such as permanent magnet or an electromagnet, generating a magnetic field driven by a means for motion to spin the rotor, while simultaneously interacting magnetically with a stator generating a stationary magnetic field. Accordingly, one magnetic field source is stationary and the other is a moving source of magnetic field.

The invention and method of propulsion employs Newton's Third Law of motion in three simultaneous frames of reference. The first frame is the non-inertial frame of reference of a spinning rotor. A body in motion with acceleration; like a spinning rotor, is a non-inertial frame of reference. As a non-inertial frame of reference, in a rotor, such a cylinder or a disk spinning about its own geometric center of revolution, all the particles in the rotor accelerate toward the center of revolution. Furthermore, the action of a force on a spinning rotor generates gyroscopic forces in accordance with the principles of gyroscopic operations. The second frame is an inertial frame of reference. A body at rest or a body in motion at a constant velocity; is an inertial frame of reference that conserves momentum and energy. A stator comprising a permanent magnet or an electromagnet providing a stationary magnetic field is an inertial frame of reference. And the third frame is a magnetic field frame of reference that employs the Newton's Third Law Exception as is known in electrodynamics and modern physics. Each frame of reference cooperates with the other frames of reference in a synergy that is governed by the laws of physics in that frame of reference.

The operation that generates propellantless propulsion and therefore propellantless thrust; employs the magnetic forces present in the magnetic fields of permanent magnets and electromagnets to produce gyroscopic forces and Lorentz forces with the action at a distance of magnetic fields.

The means for the rotation of a rotor providing a magnetic field can be an electric motor or any other suitable power source that conveys the spinning rotor and its magnetic field, a predetermined momentum and energy of motion that conveys the spinning rotor and its magnetic field with angular momentum and energy of motion. The motion of the magnetic field traversing the stationary magnetic field in a stator generates a magnetic interaction between the stationary magnetic field and the moving magnetic field that produce gyroscopic forces in the spinning rotor, and Lorentz forces in the stator.

In the operation that generates propellantless thrust, the Newton's Third Law action is the motion of the rotor's magnetic field through the magnetic space of another magnetic field. The magnetic interactions between the magnetic fields generate in the rotor a directional gyroscopic force in accordance with the principles of gyroscopic operation. And simultaneously, the magnetic interaction between the magnetic fields also generates; a directional Lorentz force in the stator without the expulsion of propellant, and without an equal and opposite Newton Third Law reaction; as recognized in the exception to Newton's Third Law of motion in agreement with the established principles of electrodynamics and modern physics. In the rotor and the stator, the gyroscopic forces and the Lorentz forces are produced with the action at a distance of magnetic fields. The gyroscopic forces and the Lorentz forces are the sources of propellantless thrust for propulsion.

The current embodiments are capable of generating continuous thrust with the input of electric energy to an electric motor as the means that rotates the rotor permanent magnet or the electromagnet supplying the magnetic field. Embodiments of the present invention are novel and distinct in the manner in which the propellantless thrust is produced as a gyroscopic force and as a Lorentz force.

Engineering analysis and experiments show significant improvements in the thrust level produced with significant lower power consumption without propellant ejection, as compared to other means of propulsion. No evidence has been found in the literature and in the prior art pertaining to the manner in which propulsion thrust is produced as herein described, and in the embodiment of the novel propulsion system and method that generates propellantless thrust.

### BRIEF DESCRIPTION OF THE DRAWINGS

FIG. 1A shows Ampere's discovery on how two orthogonal currents produce an exception to Newton's Third Law between perpendicular currents.

FIG. 1B shows how magnetic interactions between charged particles induce and generate an unbalanced Lorentz force between charged particles moving orthogonally in the same plane.

FIG. 2 shows that applying a force on the spinning rotor of a gyroscope produce a gyroscopic force that causes precession.

FIG. 3 shows in schematic an embodiment comprising the essential elements that generate a gyroscopic force and a Lorentz force as sources of propellantless thrust.

FIG. 4A shows a sectional plan view of FIG. 3 illustrates with magnetic field lines the magnetic field interactions between the orthogonal magnetic fields of a spinning rotor and a stator that generates the forces that make up the propellantless thrust of propulsion.

FIG. 4B is a plan view of FIG. 4A showing the dynamics of how a rotor magnetic field interacting with the stator magnetic field generates a gyroscopic force and a Lorentz force comprising the propellantless thrust of propulsion.

FIG. 5 shows the essential elements for propulsion mounted on a frame to which the propulsion system is attached to for propulsion.

FIG. 6 shows another embodiment comprising two counter rotating sources of magnetic field interacting magnetically with a stationary magnetic field source.

FIG. 7A is a cross section of FIG. 6 showing the two counter rotating sources of magnetic field showing with magnetic field lines, the orthogonal magnetic fields orientation and the magnetic interactions between the rotors and the stator.

FIG. 7B is a plan view of FIG. 7A showing how the rotors magnetic field interactions with the stator's magnetic field generates a gyroscopic force and a Lorentz force that add up as the propellantless thrust of propulsion.

FIG. 8 shows the two counter rotating rotors and stator embodiment in FIG. 6 mounted on a frame platform that can be attached to a vehicle for propulsion.

### DETAILED DESCRIPTION OF PREFERRED EMBODIMENTS

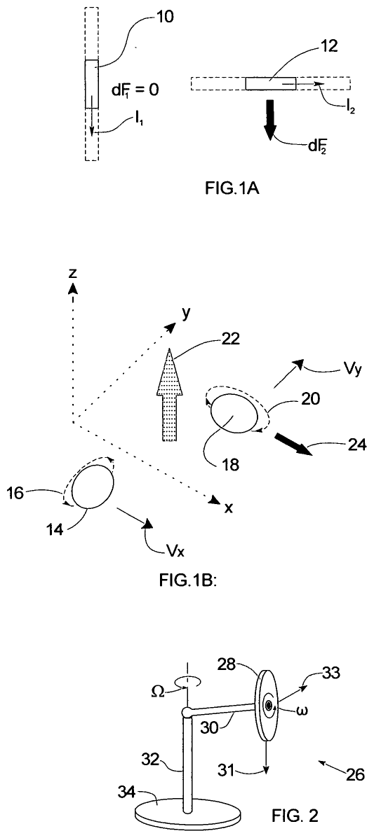

### FIG. 1A

By way of background and initially with reference to FIG. 1A, about two centuries ago, the French scientist André Marié Ampére established and discovered many of the scientific principles in the electrical science. One of Ampére discoveries relates to forces between pendicular currents. A first current in one direction exerts a force on a second perpendicular current; while the second current does not exert and equal and opposite force on the first current. This particular discovery by Ampére has been overlooked and ignored in propulsion because reactionless propulsion is thought to be impossible.

FIG. 1A illustrates Ampére's discovery about orthogonal or perpendicular currents. In a current segment 10, a current I₁ flows in a vertical direction. While in a current segment 12, positioned in a horizontal direction perpendicular to the current segment 10, a second current I₂ flows horizontally perpendicular to the first current I₁. In this setup, the current I₁ exerts a force dF₂ on the current segment 12. While the current I₂; does not exert an equal and opposite force on the current segment 10. Accordingly, the force dF₁ on the current segment 10 from the current I₂ in the current segment 12 is zero (dF₁=0).

In current electrodynamics and modern physics, the force dF₂ is recognized as a Lorentz force and it appears to be a violation to Newton's Third Law (NTL). Ampére discovery has been overlooked and ignored and has not been useful in propulsion because is only applicable to isolated current segments. When all the forces produced by electric currents in complete circuits are taken into account, NTL is satisfied. And that explains why electric appliances such as computers, televisions, radios and the like; do not propel themselves with the electric currents in the circuit.

### FIG. 1B

In FIG. 1B, for two coplanar particles (electrons and protons) moving at right angle to each other, it is well known by those skilled in the art, that a charged particle 14 moving with velocity Vₓ parallel to the x-axis as shown, will exerts a force on another charged particle 18 moving orthogonally on the same plane parallel to the y-axis with velocity V_{y}.

It is also known in the art that a particle makes a magnetic field along its line of motion. And in the line of motion, particle 14 makes a magnetic field 16. Similarly, in its line of motion, charged particle 18 makes a magnetic field 20. Because the movement of charged particle 18 is orthogonal to the path of charged particle 14; the magnetic field 20 of particle 18 is also orthogonal to the magnetic field 16 of charged particle 14.

As FIG. 1B illustrates, particle 18 is in an orthogonal line of motion in relation to particle 14 and in the path of movement of magnetic field 16; inducing on particle 18 a magnetic field 22 parallel to the z-axis. The magnetic interactions between the particle 14 with magnetic field 16 and particle 18 with magnetic field 20; generates the induced magnetic field 22 that also generates a Lorentz force 24. In this orthogonal magnetic interaction between particles and fields, particle 14 applies a force on particle 18. While particle 18 does not apply and equal and opposite reaction force on particle 14 contrary to the postulates of Newton's Third Law (NTL) “For every action there is an equal and opposite reaction.” This exception to NTL is well known, well studied, and well understood to those skilled in the art and is part of electrodynamics and modern physics. The Newton's Third Law Exception (NTLE) is one situation the present propulsion system and method exploits and takes advantage of to engineer a practical and useful propellantless propulsion prime mover as herein disclosed.

As is well known, the magnetic fields of permanent magnets and energized electromagnets have North (N) and South (S) magnetic poles that interact magnetically in accordance to the polarity and orientation of the poles. As a general rules, unlike magnetic poles attract each other, and like poles repel each other.

### FIG. 2

By way of additional background, FIG. 2 shows a gyroscope 26 comprising a disk first rotor 28 pivotally mounted for rotation on a shaft 30 spinning in the counter clockwise direction at an angular velocity ω. The shaft 30 is also pivotally mounted for rotational precession at a precession velocity Ω about a vertical shaft 32 mounted on a base 34.

The spinning rotor 28 is a non-inertial frame of reference. It is also well known in gyroscope science that, an input force 31 applied on the spinning rotor 28 produces an output force 33, at about ninety degrees (90° or π/2) ahead from the applied input force 31 in the direction of rotation. The output force 33 produces a torque that causes the first rotor 28 to spin about the shaft 32 with the precession angular velocity Ω. The vector force direction of the output force 33 is perpendicular to the input force 31.

FIG. 2 shows the rotor 28 under the influence of the applied input force 31 generating the gyroscopic output force 33. The applied input force 31 can be the force of gravity, the force of a physical contact, or the force of a magnetic field on the gyroscope. In the absence of any other force for the most part, gravity is the agent taking the role of the input force 31 in the gyroscope 26. The operation of the gyroscope 26 shows the output force 33 causes the gyroscopic precession around the shaft 32 with the precession angular velocity Ω, as is well known and well understood by those skilled in the art. The magnitude of the output force 33 is a byproduct of the input force 31, the rotor 28 moment of inertia, the angular velocity ω, and the radius of gyration between the vertical shaft 32 and the first rotor 28. The radius of gyration is the length of the shaft 30.

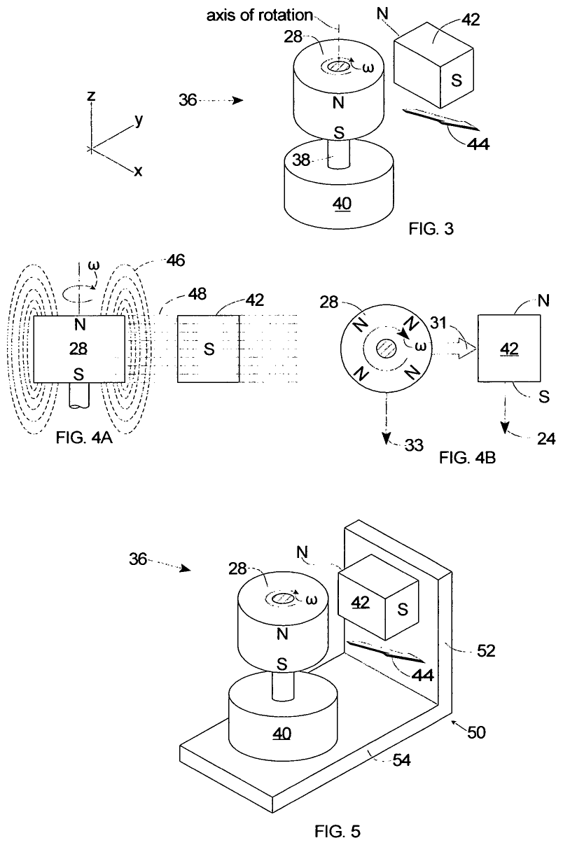

### FIG. 3

FIG. 3 shows the essential elements that exploit the synergy in the operation of the gyroscope 26, and in the Newton's Third Law Exception (as in FIG. 1 and FIG. 2); to engineer a practical and useful propellantless prime mover for propulsion. FIG. 3 shows a propulsion system 36 comprising a first rotor 28 mounted on the shaft 38 of a first means for motion 40; and a stator 42 adjacent to, angularly spaced, and radially disposed at a predetermined distance from the first rotor 28. The propulsion system 36 generates a propellantless propulsion force 44.

The first rotor 28 is a first source of magnetic field that generates a first magnetic field, shown with the letters N and S, for magnetic interaction with the stator 42 that as a source of magnetic field; provides a stationary second magnetic field for magnetic interaction with the first rotor 28 first magnetic field. Both, the first magnetic field and the second magnetic field are shown with the letters N and S to indicate magnetic poles. The symbol N stand for the North magnetic pole; and the symbol S stand for the South magnetic pole.

The first magnetic field with origin in the first rotor 28; is parallel to the z axis in relation to the (x, y, z) coordinate system shown in FIG. 3. Similarly, the second magnetic field with origin in the stator 42 is parallel to the x axis and orthogonal to the first magnetic field. Just as Ampére found out, those skilled in the art know, the orthogonal orientation between magnetic fields is the optimal orientation to obtain maximum results. However, for applications in various embodiments, the magnetic fields can be set in various angular orientations in addition to the orthogonal alignment.

For considerations as an embodiment, the means for motion 40 is an electric motor that produce the rotary motion that convey the first rotor 28 with an angular momentum and energy of motion also shared with the rotor 28 magnetic field. Electric motors are articles of commerce. Electric motors convert electricity to rotary motion made available as a torque to rotate the first rotor 28, for conversion to the angular momentum and rotary energy of motion that become a gyroscopic output force 33, and a directional Lorentz force 24 with the magnetic interactions between the spinning first magnetic field and the stationary second magnetic field. Additional means for motion such as gas turbines and internal combustion engines are equally applicable for applications in alternate embodiments to generate propellantless propulsion.

In the present embodiment (as utilized in experiments), the first rotor 28 is a permanent magnet generating its own magnetic field. As a source of magnetic field, a permanent magnet can be replaced with an electromagnet with the supporting electrical circuitry (no shown) to generate magnetic fields. The gyrations of the first rotor 28 convey an angular momentum and energy of motion to the first rotor 28 spinning the first magnetic field.

In an electromagnetic mode, the construction of the first rotor 28 can be practiced as an assembly of coils segments in a cylindrical arrangement with the supporting electric circuits to generate; magnetic fields of predetermined amplitudes and intensity to cooperate and interact magnetically with a stationary magnetic field in the operation that generate propellantless thrust as the Lorentz force 24; and the gyroscopic output force 33; produced with the gyrations of the first rotor 28 while interacting magnetically with the stator 42 second magnetic field.

In FIG. 3, the stator 42 is radially disposed at a predetermined distance from the first rotor 28 axis of rotation, circumferentially disposed at a predetermined angular position from the first rotor 28, on one side of the stator 42 in a position adjacent to, and in a predetermined angular alignment with the first rotor 28. The stator 42 can be a permanent magnet such as a Neodymium magnet or any other type of permanent magnet, or an electromagnet coil to generate the second magnetic field when electrically energized.

The first rotor 28 spins at a predetermined angular velocity ω and frequency. For exemplification only, if the first magnetic field were confined to a single magnetic field line, the field line will also have the same spinning angular velocity ω and rotational frequency as the first rotor 28. The graphical representation for the magnetic fields with magnetic field lines of force in the propulsion system 36 is included for the ease of visual convenience.

It is well known in modern physics that the force of a particle moving through a magnetic can be measured as a Lorentz force proportional to the charge of the particle, the vector cross-product of the particle velocity and the sine of the angle between the particle path and the magnetic field at the particle location. Similarly, the motion of the first magnetic field, originating in the first rotor 28, in motion through the space of the stator 42 second magnetic field; generates the Lorentz force 24. The magnitude of the Lorentz force 24 produced during the period of interaction between the first magnetic field and the second magnetic field is equally proportional to the magnitude of the magnetic fields in terms of magnetic intensity, inversely proportional to the separation distance between the fields of the first rotor 28 and the stator 42, the angular orientation between the fields, and the vector cross product of the angular velocity at which the first magnetic field moves through the second magnetic field, and the sine of the angle between the first and the second magnetic field.

The propellantless propulsion force 44 or the thrust the propulsion system 36 generates, occurs as the first rotor 28 rotates with the first magnetic field; causing with the movement of the first magnetic field through the magnetic space of the second magnetic field to generate a magnetic field interaction between the fields. The magnetic interaction simultaneously act as the gyroscopic input force 31 that generate the gyroscopic output force 33 with the spinning motion of the first rotor 28, and also generate the Lorentz force 24. The spinning motion of the first magnetic field has a momentum and energy of motion that can be measured with the first rotor 28 angular velocity ω. The motion of the first magnetic field traversing through the stator 42 second magnetic field generates the Lorentz force 24 without an equal and opposite reaction, and without the expulsion of propellant.

### FIG. 4A

FIG. 4A is a sectional view of the first rotor 28 and the stator 42 in which the first and second magnetic fields are shown with magnetic lines of force; cooperate and interact magnetically to generate thrust without propellant. The first magnetic field 46 is described with magnetic field lines of force parallel to the first rotor 28 axis of rotation. The second magnetic field 48 is also shown with magnetic lines of force perpendicular to the first rotor 28 axis of rotation and also perpendicular to the first magnetic field 46 lines of force. The magnetic fields 46 and 48 are shown with magnetic field lines of force as a visual picture to show the orthogonal magnetic fields 46 and 48 orthogonal interaction. FIG. 4A, in a cross section view section shows the magnetic field lines orientation in an alignment of orthogonal magnetic interactions between the first magnetic field 46 and the second magnetic field 48.

### FIG. 4B

FIG. 4B, in a top plan view of FIG. 4A illustrates how with an action at a distance, the magnetic interactions between the first rotor 28 and the stator 42 second magnetic field generates the propulsive Lorentz force 24, the gyroscopic input force 31 and the gyroscopic output force 33. The first rotor 28 spins clockwise with the angular velocity ω; while the rotor 28 first magnetic field 46 interact and travel through the magnetic space of the stator 42 second magnetic field 48. In agreement with the operation that generates gyroscopic forces with a spinning rotor; and with the action at a distance of magnetic fields interactions, the angular momentum and energy of motion in the spinning first rotor 28, with the magnetic field interaction between the first magnetic field and the stator second magnetic field; communicate to the first rotor 28 the magnetic field input force 31, that as a consequence generates the gyroscopic output force 33.

And at the same time, also generates on the stator 42 the Lorentz force 24 without an equal and opposite reaction on the first rotor 28.

The Lorentz force 24 is a byproduct of the Newton's Third Law Exception (NTLE). The NTL reaction force does not appear as an opposite force because magnetic fields, as electromagnetic radiation; is known to take up and transport away the NTL reaction. The NTLE is well known, well established, and is part of electrodynamics and modern physics.

Together, the Lorentz force 24 and the gyroscopic force 33; is the situation the present method of propulsion exploits to engineer the prime mover that generate propellantless thrust for propulsion.

### FIG. 5

FIG. 5 illustrates the propulsion system 36 mounted on an L bracket frame 50. The first rotor 28 is aligned in the frame 50 in a close proximity to the stator 42. The L bracket frame 50 forms a structure for attachment to a vehicle for propulsion. The frame 50 comprises a vertical member 52 and a horizontal member 54. The member 54 provides structural support for the means for motion 40. While the vertical arm 52 provides structural support for the stator 42. The propulsion system 36 can directly propel the frame 50; or the frame 50 can be the vehicle to which the propulsion system 36 is mounted on for propulsion.

FIG. 5 is a suitable propulsion assembly to provide propulsion for on land, air, water, and space travel. Some examples of transportation vehicles are cars, vans, buses, trucks, aircrafts, naval ships, submarines, satellites in orbit, and spaceships for space travel. Those skilled in art can in effect design the appropriate and suitable means to supply the power to operate the propulsion system 36 to generate the thrust of propulsion. Whether to use permanent magnets, electromagnets or a combination of both to produce the required magnetic fields to generate thrust of propulsion. The sources of electric power and connections for the electric motor(s) and for the electromagnets can be made in accordance with the known standards and technology available at the time of implementation.

FIG. 5 represents the essential elements as a model for an embodiment (among many) employed to carry out a variety of experiments to test for propellantless thrust successfully. The tests were done with electric motors and cylindrical Neodymium permanent magnet rotor mounted on the motor's shaft. Together with a second Neodymium magnet(s) mounted on a vertical beam as the stator. The assembled test components were mounted on a platform with roller ball bearing casters to allow for the platform free movement in any direction. The supporting electronics to control the motor speed, and the three phase motor(s) used; is of the type commonly found in hobby type drones and model airplanes powered by LiPo batteries.

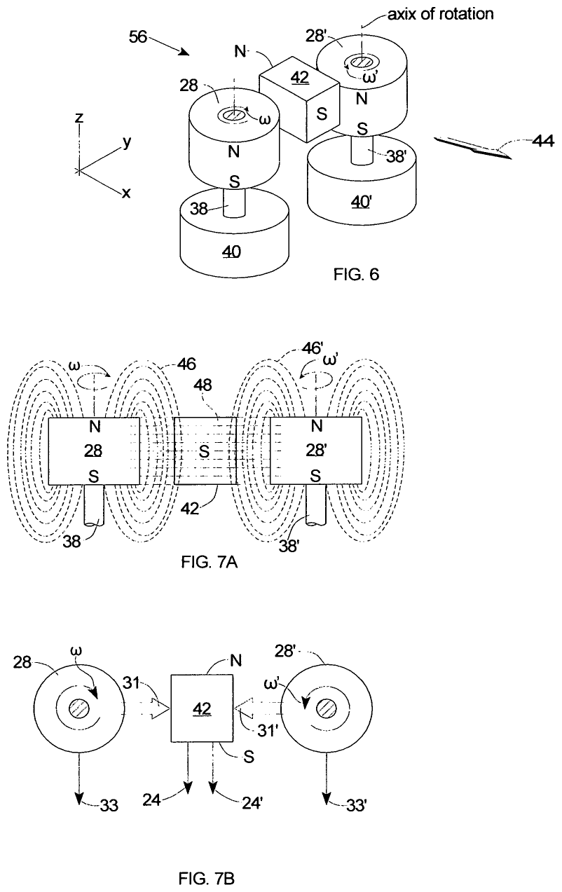

FIG. 6 shows the essential elements that generate propellantless thrust assembled as an improved propulsion system 56. The improvement comprising, an analogous second and thrust

### FIG. 6

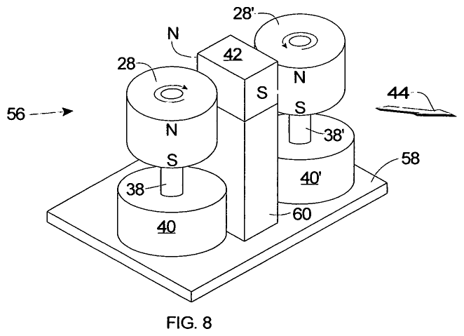

generating assembly comprising a second rotor 28′ that rotates in the counterclockwise direction with the angular velocity ω′. The second rotor 28′ is mounted on the shaft 38′ of a second means for motion 40′. The assembly of the second rotor 28′ mounted on the second means for motion 40′ is adjacent to, radially disposed, and angularly disposed at a predetermined distance from the stator 42, in a position also parallel to the z axis in the coordinate system shown. In a position across the stator 42 on the opposite side to the assembly of the first rotor 28 and the first means for motion 40. The second rotor 28′ provides a third magnetic field for magnetic field magnetic interactions with the second magnetic field from the stator 42. The magnetic interactions between the first rotor 28 providing the first magnetic field; and the second first rotor 28′ providing a third magnetic field, simultaneously interact magnetically with the stator 42 second magnetic field and generates the propellantless propulsion force 44. The first rotor 28 interacts magnetically with one side of the stator 42; while the second rotor 28′ interacts magnetically with the other side of stator 42. The operation that generates the propulsion force 44 in the propulsion system 56 is best described in FIG. 7.

The means for motion 40 and 42′ are analogous. Also rotors 38 and 38′ are also analogous to each other. However, to make a distinction for exemplification, the added components are marked with the modifier letter prime (′) with the component number. In the (x, y, z) coordinate system shown in FIG. 6, the third magnetic field N-S magnetic vector from the second rotor 28′ is also parallel to the z axis and parallel to the first rotor 28′ axis of rotation.

### FIG. 7A

For exemplification only, FIG. 7A shows with magnetic field lines the first magnetic field 46, the second magnetic field 48, and the third magnetic field 46′. The first rotor 28 provides the first magnetic field shown with magnetic lines as magnetic field 46. The second rotor 28′ provides the third magnetic field shown with magnetic lines as the third magnetic field 46′. With both magnetic fields 46 and 46′ interacting magnetically with the stator 42 second magnetic field shown magnetic lines as second magnetic field 48. Both magnetic fields 38 and 38′ are orthogonal to the stator 42 second magnetic field 48.

### FIG. 7B

FIG. 7B is a top plan view of FIG. 7A showing the propulsion forces produced in the propulsion system 56. Similar to the operation in the propulsion system 36; on the left side, the first rotor 28 rotates clockwise with the angular velocity ω while exerting on the stator 42, the input force 31 that generates the gyroscopic output force 33 at about the ninety degrees position from the input force 31, in the clockwise direction of rotation ω. Simultaneously, the magnetic field interactions between magnetic fields of the first rotor 28 and the stator 42 generate the Lorentz force 24.

On the right side in FIG. 7B, the second rotor 28′ spins counterclockwise with the angular velocity ω′. With the spin energy of the second rotor 28′, the third magnetic field interactions with the stator 42 second magnetic field generates the input force 31′ that generate the gyroscopic output force 33. The input force 31′ shown with an arrow; generates the gyroscopic force 33′ ahead of and at about the ninety degrees position from the input force 31′. Also simultaneously, the magnetic field interactions between the stator 42 second magnetic field 48, orthogonal to the first rotor 28′ third magnetic field 46′ generates the Lorentz force 24′. The vector sum of all the gyroscopic forces 33 and 33′, and the Lorentz forces 24 and 24′ cooperate to produce the net propellantless propulsion force 44 in the propulsion system 56.

### FIG. 8

FIG. 8 shows the propulsion system 56 mounted on a single member frame 58. A member 60 supports the stator 42 in a position in between the first rotor 28 and the second first rotor 28′. As an assembly for propulsion, the propulsion system 56 can directly propel the frame 58; or the frame 58 can be the vehicle to which the system 56 is mounted on with suitable means to provide the thrust of propulsion.

### CONCLUSIONS, RAMIFICATIONS, AND SCOPE

The embodiment(s) disclosed is(are) a novel propulsion system and method utilizing the magnetic interactions between a single and or several spinning magnetic fields in motion through the magnetic field space of a stationary magnetic field. With action at a distance, the magnetic interactions between the fields generate gyroscopic forces and Lorentz forces that become the thrust of propulsion without the ejection of propellant.

The novel propulsion system is adaptable to employ means for motion such as an electric motor, an internal combustion engine with a transmission, or a gas turbine to spin a single or a plurality of permanent magnets or electromagnets to convey the magnetic fields of permanent magnet(s) and electromagnet(s), with an angular momentum and energy of motion that generate propellantless thrust. The propellantless thrust can be produced with the magnetic interactions between a single or a plurality of magnetic fields in motion through the magnetic space of a single or a plurality (not shown) of stationary magnetic fields.

With regard to the angular orientation between magnetic fields, the North-South magnetic vector orientation between the fields can be any suitable angle that generates a net force. With the maximum net force obtainable when the magnetic fields are orthogonal.

Accordingly, the teachings above can be carried out in the form multiple embodiments with derivatives and permutations of the principle disclosed in accordance in the operations of magnetic fields interactions. For example, in an (x, y, z) coordinate system, one such embodiment is, one rotor with an axial orientation parallel to the z axis magnetically interacting with another rotor in an orthogonal orientation parallel to either the x or y axes, or at an angle between the axes. Another derivative embodiment is one rotor with an axial orientation parallel to the z axis magnetically interacting with a stator magnet while another rotor in an orthogonal orientation parallel to either the x or y axes interact magnetically with the same stator.

Another embodiment is the assembly of three spinning sources of magnetic field interacting with each other. Another derivative embodiment is the same three spinning sources of magnetic field interacting with a stationary magnetic field to generate gyroscopic forces and Lorentz forces.

The spinning of a rotor makes the rotor a non-inertial frame of reference with magnetic field motion that generates propellantless thrust in the form of gyroscopic forces and Lorentz forces. Accordingly, propellantless thrust can be produced with the magnetic fields of permanent magnets and electromagnets, and the energetic magnetic interaction between magnetic and electromagnetic fields.

Other embodiments comprise the use of Halbach arrays of permanent magnets and electromagnets in the rotor that generate the moving magnetic field, and in the stator that generate the stationary magnetic field. The spinning rotor(s) can be assembled to include an array of permanent magnets; or an array of Halbach electromagnets. Similarly, the stator or stationary source of magnetic field also may include a Halbach array arrangement or permanent magnets and/or electromagnets. This particular embodiment may be carried out as a combination of a single Halbach array rotor interacting magnetically with a single Halbach array stator, or two rotating Halbach arrays interacting with each other, or two rotating Halbach arrays interacting with a single Halbach array stator, or a single Halbach array rotor in one coordinate axis interacting magnetically with two Halbach array magnetic stators with each Halbach array stator mounted in the remaining two coordinate axes in a geometric configuration of a three dimensional coordinate axes system. An additional embodiment involves three spinning rotating sources of magnetic field constructed with Halbach arrays of permanent magnets and electromagnets.

The embodiment disclosed operates with a novel method of propulsion that generates thrust without the expulsion of propellant, and without reaction as an exception to Newton's Third Law in accordance with established principles of modern physics and electrodynamics. The thrust is produced by the magnetic interaction between two or more magnetic fields. When one magnetic field has momentum and energy of motion and moves through the magnetic space of another magnetic field, the magnetic interaction between the magnetic fields generates directional gyroscopic forces and Lorentz forces.

The propulsive gyroscopic and Lorentz force are a byproduct of magnetic fields interactions, and consequently, the magnitude of the propellantless thrust output can be considerably increased and enhanced with superconductivity. Considerable high magnitude gyroscopic forces and Lorentz forces can be achieved with superconducting magnets. With superconductivity, propellantless propulsion will increase many times over to a level that may not be obtainable with ordinary permanent magnets and electromagnets. The construction of the present embodiment with superconducting magnets; is a beneficial step in progress that will increase the magnitudes of the magnetic fields and therefore, the magnitude of the obtainable propellantless thrust available for propulsion.

As the reader can see with a reading of the disclosure, the present embodiment can be carried out and built with commercially available components such as permanent magnets, electromagnets, electric motors, and electronic components to construct the supporting electronic circuits. Electric energy for an electric motor as a means of motion for a rotor and the electromagnets the generate the magnetic fields for the magnetic interactions that generate the gyroscopic forces and the Lorentz forces for propulsion can be supplied with commercial batteries, fuel cells, solar cells, and other suitable power supplies.

The present embodiment has been described with reference to the accompanying drawings with like numbers referring to like elements throughout the descriptions. The embodiments may be represented in many different forms and should not be construed as limitations. Additional embodiments are possible without departing from the teachings set forth in the disclosure. Rather, these embodiments are provided so that the disclosure will be thorough and complete, and will convey the scope of the invention.

I claim:

1. A propulsion system, comprising:
at least one means for motion to convey a rotor with rotational energy of motion,
at least one source of magnetic field mounted on said means for motion generating a magnetic field,
a stationary source of magnetic field generating a magnetic field,
wherein said means for motion convey rotational energy at a predetermined angular velocity to said rotor, wherein said rotor as a source of magnetic field interact magnetically with said stationary source of magnetic field to generate a gyroscopic force and a Lorentz force.

2. The propulsion system in claim 1 wherein said means for motion is an electric motor to convey rotational energy to said rotor as a first rotor.

3. The propulsion system in claim 1 wherein said rotor as a source of magnetic field generates a first magnetic field with a permanent magnet.

4. The propulsion system in claim 1 wherein said rotor as a source of magnetic field is an electromagnet generating a first magnetic field.

5. The propulsion system in claim 1 wherein said stationary source of magnetic field is a stator generating a second magnetic field with a permanent magnet.

6. The propulsion system in claim 1 wherein said stationary source of magnetic field is a stator generating a second magnetic field with an electromagnet.

7. The propulsion system in claim 1 with a second means for motion conveys rotational energy of motion to a second rotor as a source of magnetic field wherein said second rotor generates a third magnetic field.

8. The propulsion system in claim 7 wherein said second rotor is a permanent magnet generating said third magnetic field.

9. The propulsion system in claim 7 wherein said second rotor is an electromagnet generating said third magnetic field.

10. A propulsion method, comprising:
providing at least one means for motion to convey a rotor with rotational energy of motion at a predetermined angular velocity,
providing a source of magnetic field mounted on said means for motion generating a magnetic field,
providing a stationary source of magnetic field generating a stationary magnetic field,
wherein said means for motion convey rotational energy to said rotor as source of magnetic field at a predetermined angular velocity to interact magnetically with said stationary source of magnetic field to generate a gyroscopic force and a Lorentz force.

11. The propulsion method in claim 10 wherein said means for motion is an electric motor to convey rotational energy to said rotor as a first rotor.

12. The propulsion method in claim 10 wherein said first rotor is a source of magnetic field generating a first magnetic field with a permanent magnet.

13. The propulsion method in claim 10 wherein said rotor as a source of magnetic field is an electromagnet generating said magnetic field as a first magnetic field.

14. The propulsion method in claim 10 wherein said stationary source of magnetic field is a stator generating a second magnetic field.

15. The propulsion method in claim 10 wherein one of said means for motion has a second rotor as a third source of magnetic field providing a third magnetic field.

16. The propulsion system in claim 15 wherein said second rotor is a permanent magnet providing a third magnetic field.

17. The propulsion system in claim 15 wherein said second rotor is an electromagnet providing a third magnetic field.
